(19) United States
(12) Patent Application Publication
(10) Pub. No.: US 2026/0049690 A1
(43) Pub. Date: Feb. 19, 2026

(54) MACHINING SYSTEM WITH HAZARD DETECTION SYSTEM

(71) Applicant: JPW Industries Inc., Lavergne, TN (US)

(72) Inventor: Abhijeet Khangar, Brentwood, TN (US)

(21) Appl. No.: 19/303,756

(22) Filed: Aug. 19, 2025

Related U.S. Application Data
(60) Provisional application No. 63/684,708, filed on Aug. 19, 2024.

(51) Int. Cl. F16P 3/14; B27G 19/02

(52) U.S. Cl. CPC F16P 3/142; B27G 19/022

(57) ABSTRACT

A machining system for wood or metal working is disclosed that incorporates a non-contact hazard detection and mitigation system to protect an operator from accidental contact with a working element such as a saw blade or the like. The system may include one or more sensors, such as two-dimensional cameras, depth sensors, three-dimensional time-of-flight sensors, thermal imagers, or electrode arrays, positioned proximate to the working element to track the location and movement of a human body part in multiple directions or planes. A controller may process sensor data to determine the position, velocity, or trajectory of the body part relative to the working element, identify hazardous situations such as entry into a hazard zone, and activate the hazard mitigation system to reduce the risk of serious injury to the human body part.

### CROSS-REFERENCES TO RELATED APPLICATIONS

This application claims priority to U.S. Provisional Patent Application Ser. No. 63/684,708 filed Aug. 19, 2024, the entirety of which is incorporated by reference herein.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

### 1. Field of the Invention

The present disclosure relates generally to machining systems. More particularly, the present disclosure pertains to protective systems and methods for detecting a proximity of a human object relative to a hazardous element of the machining system.

### 2. Description of the Prior Art

A number of different machining systems exist to facilitate forming a work piece into a desired shape. These machining systems present a safety concern because the working element of these machining systems is typically very sharp and moves at a high rate of speed. Accordingly, severe injury such as severed digits and deep lacerations can occur if an operator contacts the working element of the machining system. A number of different safety systems have been developed for machining systems in response to the dangers inherent in an exposed working element moving at high speed. Such safety systems are operable to trigger a reaction or stoppage device upon detecting or sensing the proximity or contact of some appendage of an operator with the working element of the machining system. One such detection system is a capacitive contact sensing system configured to detect contact between the operator and the working element of the machining system. The capacitive contact sensing system is very dangerous as it requires contact between the operator and the working element prior to engaging the safety system. If the system malfunctions, then severe injury may occur. Additionally, because such systems only trigger upon contact time, mitigation activities must be incredibly fast and efficient to reduce any damage to the body part in contact with the working element. As such, improvements in tooling safety systems are needed.

### BRIEF SUMMARY

In view of at least some of the above-referenced problems associated with conventional machining systems and their limited or contact-dependent safety features, an exemplary object of the present disclosure is to provide a machining system incorporating an advanced hazard detection system in combination with a rapid hazard mitigation system. The hazard detection and mitigation systems are designed to protect a body part of an operator from accidentally coming into contact with a running blade or other working element of the machining system, which can otherwise result in severe injury. Unlike prior capacitive contact sensing systems that require physical contact with the working element before a safety response is triggered, the proposed solution features a non-contact hazard detection mechanism configured to track the position and/or movement of an operator's body part in multiple directions or planes relative to the working element. Based on this tracking, the system can predictively identify hazardous situations and initiate a safety response before physical contact occurs. The hazard mitigation system may be configured to retract the working element beneath the work surface, stop or brake the working element, and/or generate an alarm, thereby reducing or preventing injury. A key advantage of this solution is that it continuously monitors body part movement and triggers a protective response prior to contact, greatly improving operator safety. In certain embodiments, the total response time, including hazard detection and hazard mitigation, may be less than 100 milliseconds, and in some embodiments less than 50 milliseconds.

In a particular embodiment, an exemplary machining system as disclosed herein may include a working element, a hazard mitigation system, a hazard detection system, and a controller operatively connected to the hazard mitigation system and the hazard detection system. The working element may be positioned adjacent to a work surface of the machining system and may include, for example, a saw blade, drill bit, router bit, or other cutting implement. The hazard mitigation system may be operatively connected to the working element and configured to take one or more protective actions such as retracting the working element beneath the work surface, stopping or slowing the working element, or activating auditory or visual alarms. The hazard detection system may be positioned proximate to the working element and may include at least one sensor configured to track a position of a human body part relative to the working element in at least one horizontal direction and in a vertical direction. The at least one horizontal direction may be parallel to the work surface, and the vertical direction may be perpendicular to the work surface. In alternative embodiments, the hazard detection system may track movement in both a plane parallel to the work surface and a plane parallel to the working element itself, thereby allowing monitoring across multiple axes or orientations.

The controller may be configured to receive and process data from the hazard detection system, determine a position and/or movement of the human body part relative to the working element, and identify a hazardous situation based on the determined position and/or movement. Upon identifying such a hazardous situation, the controller may be further configured to activate the hazard mitigation system to prevent or minimize injury. In certain embodiments, the controller may employ machine learning models, velocity thresholds, or predefined hazard zones to distinguish between normal operation and hazardous approaches, while also differentiating between human body parts and work pieces using thermal or imaging-based detection techniques.

### BRIEF DESCRIPTION OF THE SEVERAL VIEWS OF THE DRAWINGS

FIG. 1 is a front elevation view of an embodiment of a machining system in accordance with the present disclosure.

FIG. 2 is a front elevation view of an embodiment of a machining system in accordance with the present disclosure.

FIG. 3 is a top plan view of the machining system of FIG. 1 in accordance with the present disclosure.

FIG. 4 is a front elevation view of an embodiment of a machining system in accordance with the present disclosure.

FIG. 5 is a top plan view of the machining system of FIG. 4 in accordance with the present disclosure.

FIG. 6 is a view of an output from an embodiment of a hazard detection system of the machining system in accordance with the present disclosure.

FIG. 7 is a cross-sectional side view of an embodiment of the machining system in accordance with the present disclosure.

FIG. 8 is a top plan view of the machining system of FIG. 7 in accordance with the present disclosure.

FIG. 9 is a view of equipotential lines of a distorted E-Field of a hazard detection system of the machining system of FIGS. 7-8 in accordance with the present disclosure.

FIG. 10 is a flowchart outlining exemplary steps of a method of operating the machining system in accordance with the present disclosure.

FIG. 11 is a graphical view of an exemplary digital output from the hazard detection system of the machining system in accordance with the present disclosure.

FIG. 12 is a graphical view of another exemplary digital output from the hazard detection system of the machining system in accordance with the present disclosure.

FIG. 13 is a graphical view of another exemplary digital output from the hazard detection system of the machining system in accordance with the present disclosure.

FIG. 14 is a graphical view of another exemplary digital output from the hazard detection system of the machining system in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

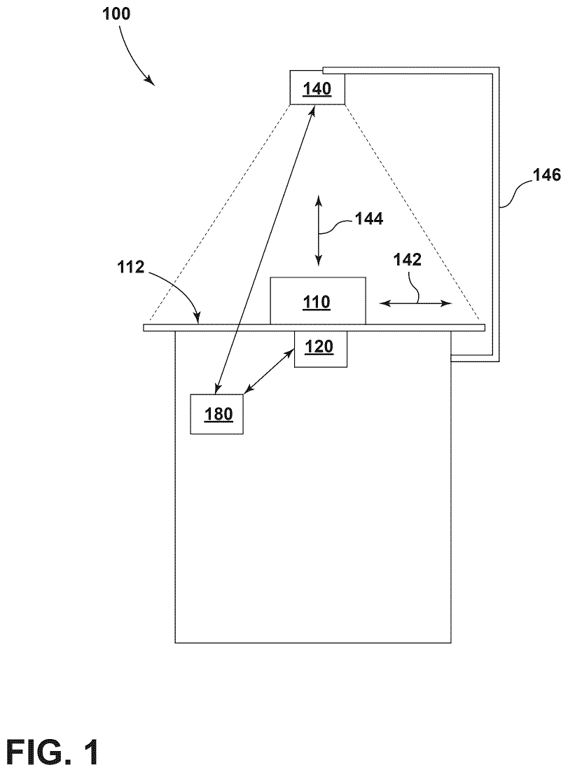

Referring to FIGS. 1-5 and 7-8, a machining system 100 is provided. The machining system 100 may include a working element 110 positioned adjacent or proximate to a work surface 112 of the machining system 100. In certain optional and nonlimiting embodiments, the machining system 100 may, for example, be a table saw, a miter saw, a router table, a planar, a jointer, a band saw, a rip saw, a panel saw, a drill press, or the like. As such, the working element 110 may be a saw blade, a drill bit, a router bit, or some other sharp implement configured to interact with a work piece, such as wood, metal, or the like. In certain optional embodiments, the working element 110 may be configured to retract below or away from the work surface 112 in less than 50 milliseconds upon detection of a hazardous condition, thereby mitigating risk of injury.

The machining system 100 may further include a hazard mitigation system 120 configured to interact with the working element to mitigate any safety risk when a dangerous condition is detected (according to the various systems and methods described herein). In some embodiments, the hazard mitigation system can be operable to alert an operator of the machining system 100 of a hazardous situation. The hazard mitigation system 120 may include one or more of an auditory alarm, a visual alarm, or a reactionary mechanical/electrical/electromechanical mechanism operatively coupled to the working element 110 for stopping the working element 110 or retracting the working element 110 beneath or away from the work surface 112 or away from the operator. In certain optional embodiments, both an alarm and a mechanical response may be employed, such that the operator is simultaneously warned while the system executes a rapid hazard-avoidance action.

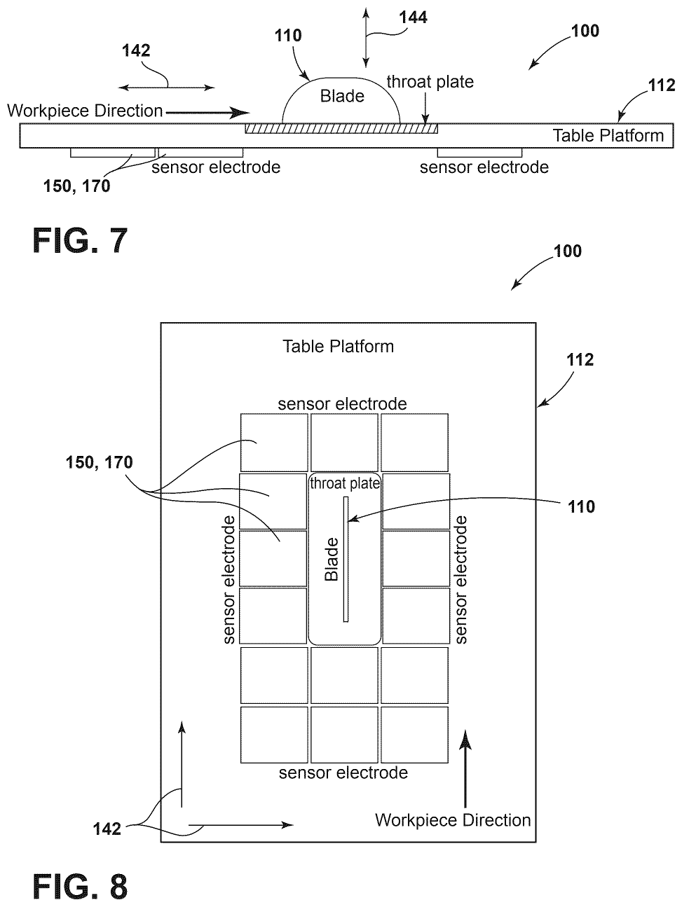

The machining system 100 may further include a hazard detection system 140 positioned proximate to the working element 110. The hazard detection system 140 may include at least one sensor 150 configured to track a position of at least one human body part 102 (as shown in FIGS. 7 and 11-14) relative to the work surface 112 in at least one horizontal direction 142 and a vertical direction 144. The at least one horizontal direction 142 may be parallel to the work surface 112 and the vertical direction 144 may be perpendicular to the work surface 112. In some embodiments, the at least one sensor 150 of the hazard detection system can detect movement of the human body part 102 along multiple horizontal directions 142 generally defining a two dimensional plane parallel with the work surface 112. The human body part 102 may, for example, be a hand, arm, or some other appendage that may accidentally contact the working element 110. In certain optional embodiments, the hazard detection system 140 may track movement in at least one first plane parallel to the work surface 112 and in at least one second plane parallel to the working element 110 itself, such as the side face of a vertically oriented saw blade.

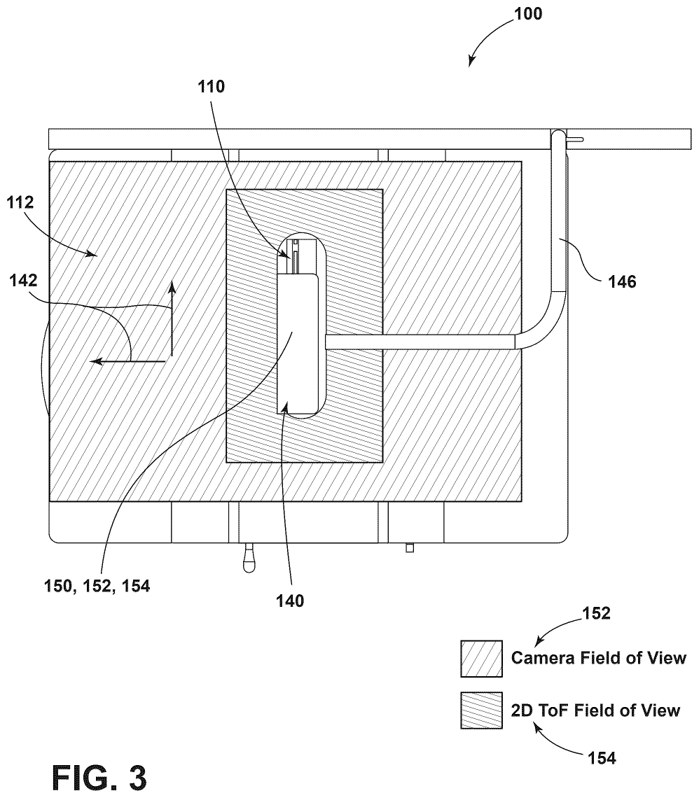

In certain optional embodiments, as illustrated in FIGS. 1 and 3, the hazard detection system 140, or a sensor thereof, may be positioned directly above the working element 110 of the machining system 100, for example, supported by a boom pole 146 or the like. In other optional embodiments, one or more of the at least one sensor 150 may be positioned generally above the work surface 112, beside the work surface 112, integrated within the work surface 112, or some other position where the sensor may have an unobstructed view of the working element 110, the work piece, and/or the human body part 102. In further optional embodiments, multiple sensors may be utilized at different locations to image or detect the user's body part from different angles. This may help separate the 3D shape of the human body part 102 versus that of the work piece. In certain optional embodiments, thermal imaging sensors may be included to distinguish body heat from cooler work pieces, and/or machine learning algorithms may be employed by the controller to distinguish between a body part and a work piece based on captured data.

The machining system 100 may further include a controller 180 operatively connected to the hazard mitigation system 120 and the hazard detection system 140. The controller 180 may be configured to determine a position and/or movement of the human body part 102 relative to the working element 110 based on outputs from the hazard detection system 140. The controller 180 may further be configured to identify a hazardous situation based on the determined position and/or movement of the human body part 102 relative to the working element 110. The controller 180 may further be configured to activate the hazard mitigation system in response to the identified hazardous situation. The hazardous situation may be based at least in part on the determined position of the human body part 102 being within a predetermined distance from the working element 110. In certain optional embodiments, the predetermined distance may be less than 100 mm, 90 mm, 80 mm, 70 mm, 65 mm, 60 mm, 55 mm, 50 mm, 45 mm, 40 mm, 35 mm, 30 mm, 25 mm, 20 mm, 15 mm, 10 mm, 9 mm, 8 mm, 7 mm, 6 mm, 5 mm, 4 mm, 3 mm, 2 mm, or 1 mm. In certain optional embodiments, the predetermined distance may be greater in front of the working element 110 than beside the working element 110. In other optional embodiments, the hazardous situation may be based at least in part on the determined position of the human body part 102 being within a predefined zone 130, 132 surrounding the working element 110. In some embodiments, the zone 130, 132 can extend further in front of the working element 110 as opposed to beside the working element 110, for instance in the case of a circular saw blade where the teeth at the circumferential edges of the saw blade are more dangerous than a side of the saw blade. In additional optional embodiments, the controller 180 may employ a velocity threshold test, such that a hazardous situation is identified if the body part moves toward the working element at a speed exceeding a predetermined value, even if it has not yet entered the hazard zone.

The hazardous situation may, in addition to or alternatively, be based at least in part on a determined movement (e.g., direction and rate of speed or velocity) of the human body part 102 relative to the working element 110. In certain optional embodiments, a hazardous situation based on the determined movement may only be realized when the human body part 102 is within the predetermined distance, some other intermediate threshold distance, or the predefined zone. In other optional embodiments, the hazardous situation based on the determined movement may be independent of whether the human body part 102 is within the predetermined distance or the predefined zone. In such cases, rapid motion toward the working element may trigger immediate retraction or stopping of the working element, independent of absolute distance.

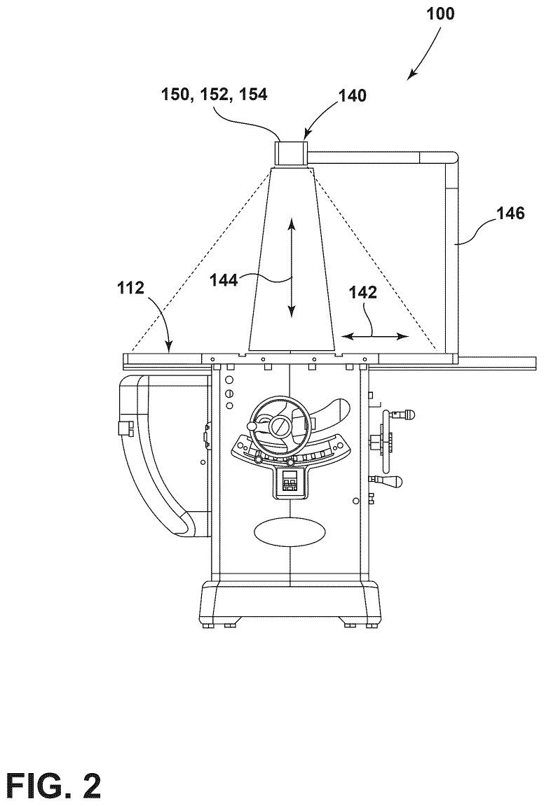

In certain optional embodiments, as illustrated in FIGS. 2-3, the at least one sensor 150 of the hazard detection system 140 may include a two-dimensional camera 152 and a depth sensor 154. The two-dimensional camera 152 may be configured to track the position of the human body part 102 relative to the working element 110 in only the at least one horizontal direction 142 or horizontal plane. The depth sensor 154 may be configured to track the position of the human body part 102 relative to the working element 110 in only the vertical direction 144. As such, the two-dimensional camera 152 may be used to the position of the human body part 102 in the horizontal direction 142, while the depth sensor 154 may be used to detect the position of the human body part 102 in the vertical direction 144 to determine both the horizontal and vertical position of the human body part 102, which can then be used to determine if a hazardous condition exists. The two-dimensional camera 152 may, for example, be an RGB Camera, a Charge-Coupled Device (CCD) Camera, a Complementary Metal-Oxide-Semiconductor (CMOS) Camera, a Digital Single-Lens Reflex (DSLR) Camera, a Mirrorless Camera, a Thermal Imaging Camera, a Laser Scanner, LiDAR (Light Detection and Ranging), or the like. The depth sensor 154 may, for example, be a 2D Time-of-Flight (ToF) Sensor, a Structured Light Depth Sensor, a Stereo Vision Depth Sensor, a Laser Range Finder (LIDAR), an Ultrasound Depth Sensor, or the like. Control logic of the controller 180 may use the two-dimensional camera 152 as the primary sensing device to track the position and/or movement of the human body part 102 and use the depth sensor 154 to check the position and/or movement in the vertical direction 144. In certain optional embodiments, if both the two-dimensional camera 152 and the depth sensor 154 indicate a hazardous situation, then the hazard mitigation system 120 will be activated in order to help mitigate or avoid any potential injury to the human body part 102 by the working element 110. In accordance with this optional embodiment, the response time of the hazard mitigation system may be less than 500 milliseconds, 400 milliseconds, 300 milliseconds, 200 milliseconds, 150 milliseconds, 140 milliseconds, 130 milliseconds, 120 milliseconds, 110 milliseconds, 100 milliseconds, 90 milliseconds, 80 milliseconds, 70 milliseconds, 60 milliseconds, 50 milliseconds, 40 milliseconds, 30 milliseconds, 20 milliseconds, or 10 milliseconds. In other optional embodiments, the response time may be faster.

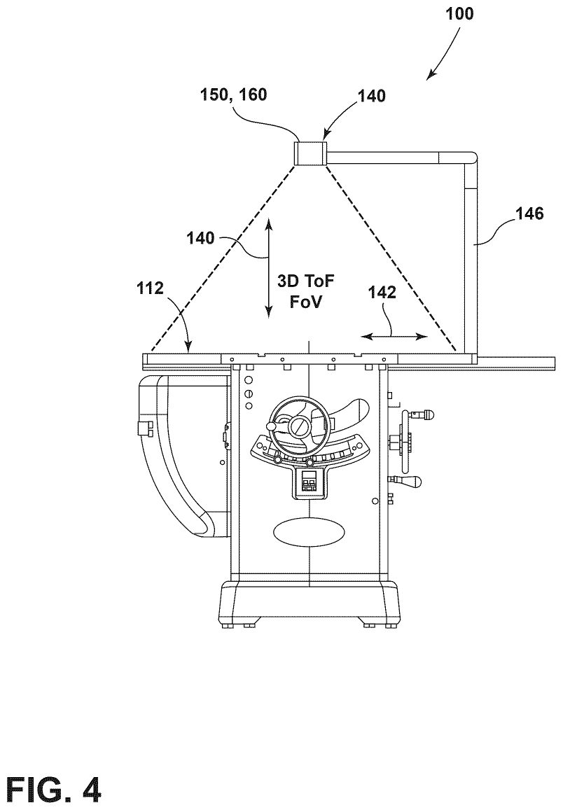

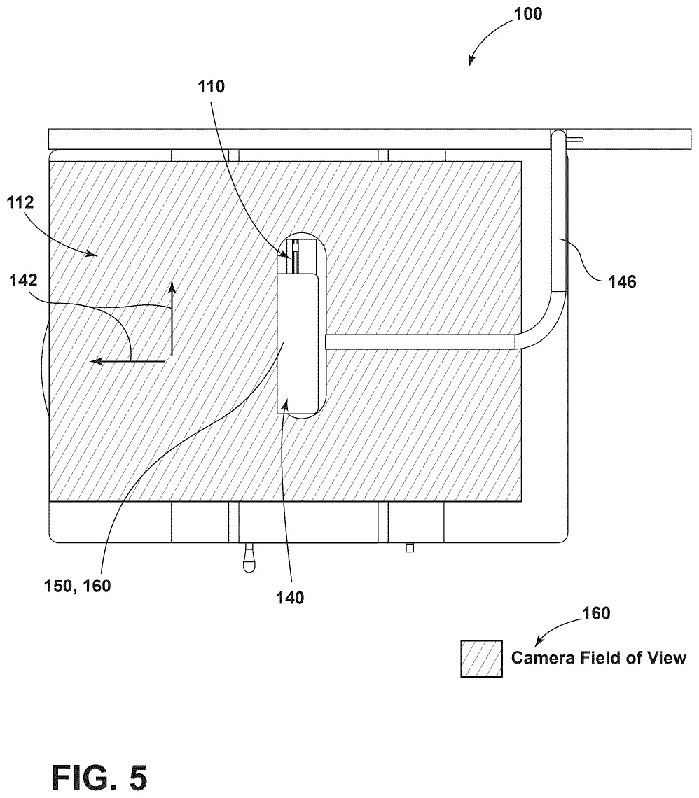

In other optional embodiments, as illustrated in FIGS. 4-5, the at least one sensor 150 of the hazard detection system 140 may include a three-dimensional sensor 160. The three-dimensional sensor 160 may be configured to track the position of the human body part 102 relative to the work surface 112 in both the at least one horizontal direction 142 and the vertical direction 144. The three-dimensional sensor 160 may, for example, be a 3D Time-of-Flight (ToF) Sensor, a Stereo Vision System, a Structured Light 3D Scanner, a Laser Range Finder (LIDAR), a Structured Light Depth Camera, an Ultrasound Positioning System, a Time-of-Flight (ToF) Camera, or the like. Control logic of the controller 180 may use the three-dimensional sensor 160 to track the position and/or movement of the human body part 102 in the at least one horizontal direction 142 and the vertical direction 144. The controller 180 may include an image processing algorithm configured to process data from the three-dimensional sensor 160 in order to identify a hazardous situation. In accordance with this optional embodiment, the response time of the hazard mitigation system 120 may be between 30 milliseconds and 80 milliseconds. In other optional embodiments, the response time may be faster.

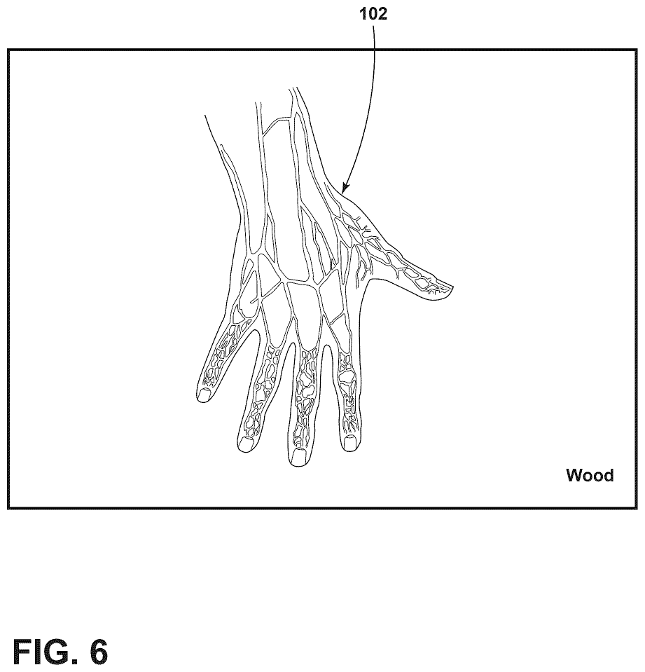

In further optional embodiments, as illustrated in FIGS. 6, the at least one sensor 150 of the hazard detection system 140 may include an infrared laser diode, a scanning mirror, and a photodiode sensor. The infrared laser diode may be configured to emit infrared light, for example, in the 700 nm to 900 nm wavelength range. The infrared light may be directed by the scanning mirror to sequentially illuminate different points on the skin's surface of the human body part 102. The infrared light may penetrate the skin and be absorbed by hemoglobin in the veins more than surrounding tissue. Some of the infrared light reflects to the surface where photodiode sensor detects the reflections. The infrared photodiode output depends on absorption by subsurface veins. As such, less light reflects from veins compared to tissue, so the photodiode voltage dips when aimed at a vein location.

The controller 180 may be configured to use the data received from the photodiode sensor to distinguish the human body part 102 from the work piece when the human body part 102 is placed on the work piece. In certain optional embodiments, the controller 180 may utilize the data to analyze the reflected near-infrared (NIR) intensity patterns, specifically the veins and bone structures in the human body part 102 should create some detectable subsurface patterns different from the work piece (e.g., solid wood). In further optional embodiments, the controller 180 may utilize the data to analyze detected temperature differences between the human body part 102 and the work piece (e.g., skin is warmer than room-temperature wood). As such, the at least one sensor 150 may further include a thermal imaging sensor. In further optional embodiments, the controller 180 may utilize the data to analyze texture and contour differences between the human body part 102 and the work piece (e.g., skin has characteristic ridges while wood grain is different). In further optional embodiments, the controller 180 may utilize the data to focus on edges of the human body part 102 as it is less likely to have the work piece confusing the sensor in peripheral areas. In further optional embodiments, the controller 180 may employ a supervised learning model to train a model on many sample cases in order learn the subtle distinguishing features between the human body part 102 and the work piece.

The embodiment leverages the unique spectral properties of blood, particularly the distinctive absorption spectrum of hemoglobin in the near-infrared (NIR) range. Hemoglobin, found in red blood cells, exhibits a peak absorption around 940 nm and a local minimum at 850 nm. This spectral signature enables differentiation of blood from surrounding tissues, as hemoglobin absorbs NIR light more strongly than water and other tissue components do. As a result, veins filled with blood reflect less NIR illumination compared to the surrounding tissues, enhancing their visibility. Additionally, blood's light scattering properties differ from those of dermal and subcutaneous tissues, further aiding in its identification and localization. These characteristics make NIR imaging and spectroscopy valuable tools in accurately identifying a position and/or movement of the human body part 102 relative to the working element 110.

When utilizing the prior embodiment, it is important to note that there are several key materials that exhibit near-infrared (NIR) absorption similar to human tissue. Wood, particularly darker and unfinished varieties, absorbs NIR in a manner akin to human skin. Similarly, animal-derived materials such as leather and suede, which share a chemical composition resembling skin, reflect and absorb NIR light in comparable ways. Fabrics and clothing, especially those dyed with darker pigments or containing carbon black dyes, also absorb NIR similarly to skin. Certain plastics, particularly those incorporating carbon black additives, exhibit NIR absorption properties that mimic human tissue. Additionally, food items like chocolate and molasses, rich in organic compounds, absorb NIR light effectively. These materials' ability to absorb NIR light in ways reminiscent of human tissue is instrumental in various applications, particularly in identification processes where shape and form factors play crucial roles.

In still further optional embodiments, as illustrated in FIGS. 7-9, the at least one sensor 150 of the hazard detection system 140 may include a plurality of electrode sensors 170 positioned within or beneath the work surface 112. The electrode sensors 170 of the hazard detection system 140 may be strategically mounted with multiple electrodes positioned around the throat plate and beneath the work surface 112 to delineate hazard and warning zones. An additional row of electrode sensors may be installed in the work piece direction to establish a supplementary warning zone. With an estimated response time of 10 milliseconds to 20 milliseconds, the sensors can detect hand movements up to 10 centimeters above the work surface 112. Output from the sensors is provided in digital format for seamless integration and processing by the controller 180. Through extensive lab testing, the solution differentiates between wood and the human body by analyzing distinct signal patterns. Moreover, the system accurately determines hand position, movement direction, and velocity based on these signal patterns. When triggered by specific signal patterns detected by the plurality of electrode sensors 170, the solution activates warning or hazard signals, ensuring timely alerts and enhanced workplace safety measures.

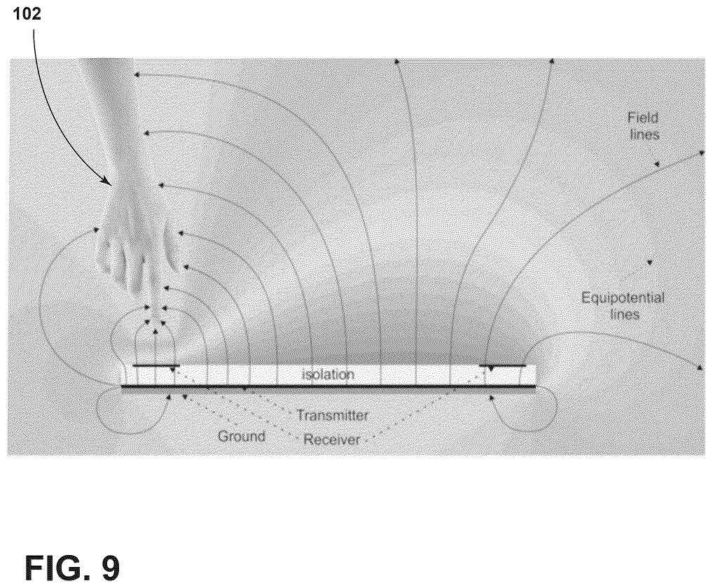

Each of the plurality of electrode sensors 170 may be a GestIC® sensor produced by Microchop Technology. The GestIC® technology is a 3D sensor system that harnesses electric fields (E-fields) to enable advanced proximity sensing capabilities. By detecting, tracking, and classifying hand gestures in free space, GestIC facilitates the development of innovative user interface applications. E-fields, generated by electric charges, propagate in three dimensions around surfaces, carrying electrical charge. The technology utilizes electrodes to produce a quasi-static electrical near field, which is effective for sensing conductive objects such as the human body. In practice, the proximity of a grounded body influences the electric field, causing compression of equipotential lines and resulting in a measured shift in signal levels at the Rx electrode to a lower potential, as depicted in FIG. 9. This capability is fundamental for GestIC®'s functionality in interpreting and responding to user gestures with precision and reliability.

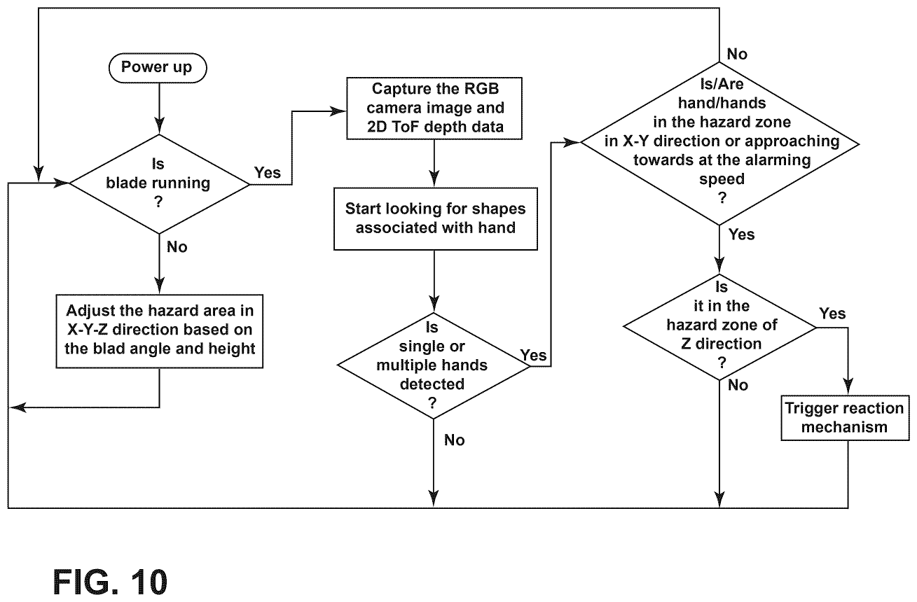

Referring to FIG. 10, a flowchart is provided which outlines the use of the machining system 100, particularly the hazard mitigation system 120 and the hazard detection system 140. The process begins with powering up the system. It first checks if the blade (e.g., working element 110) is running; if not, it adjusts the hazard area in the X-Y-Z directions (e.g., the at least one horizontal direction 142 and the vertical direction 144) based on the blade angle and height. Once the blade is running, the hazard detection system 140 captures data using the at least one sensor 150 and the controller 180 uses the data to look for shapes corresponding to the human body part 102. If no human body part 102 is detected, the hazard detection system 140 continues capturing data. If a human body part 102 is detected, one of the hazard detection system 140 or controller 180 system checks if the human body part 102 is in the hazard zone in the X-Y direction (e.g., the at least one horizontal direction 142) or approaching at an alarming speed. If not, the hazard detection system 140 returns to capturing data. If the human body part 102 is in the X-Y hazard zone, the system then checks if the human body part 102 is in the Z direction (e.g., the vertical direction 144) hazard zone. If the human body part 102 is detected in both hazard zones, the controller 180 triggers a mechanism of the hazard mitigation system 120 to prevent injury. This continuous monitoring and adjustment ensure the safety of the operator around the working element 110 when operational.

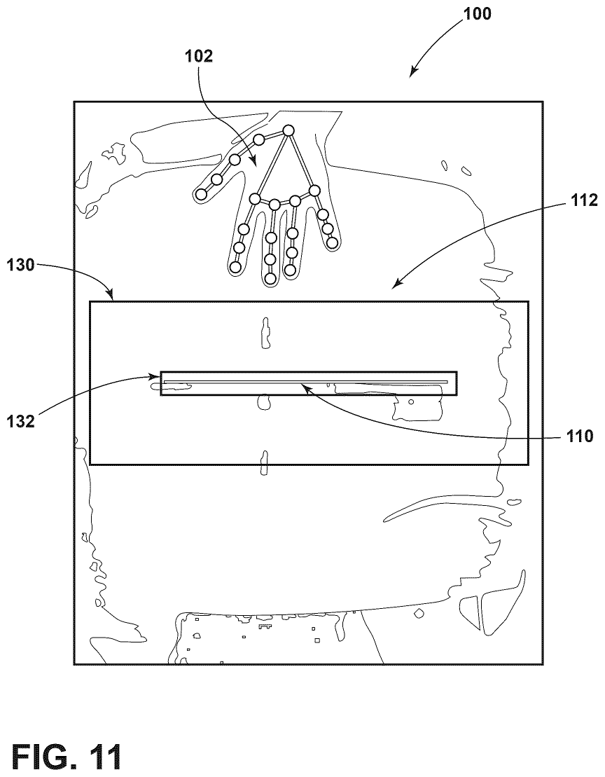

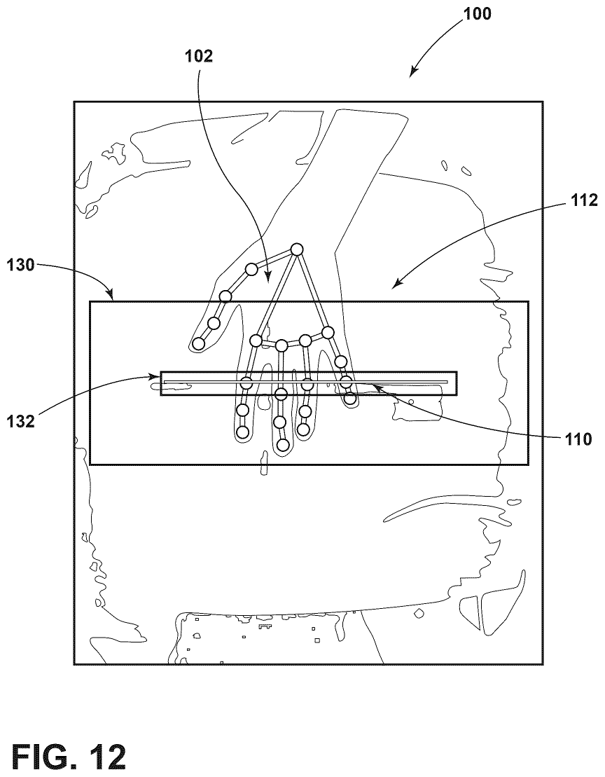

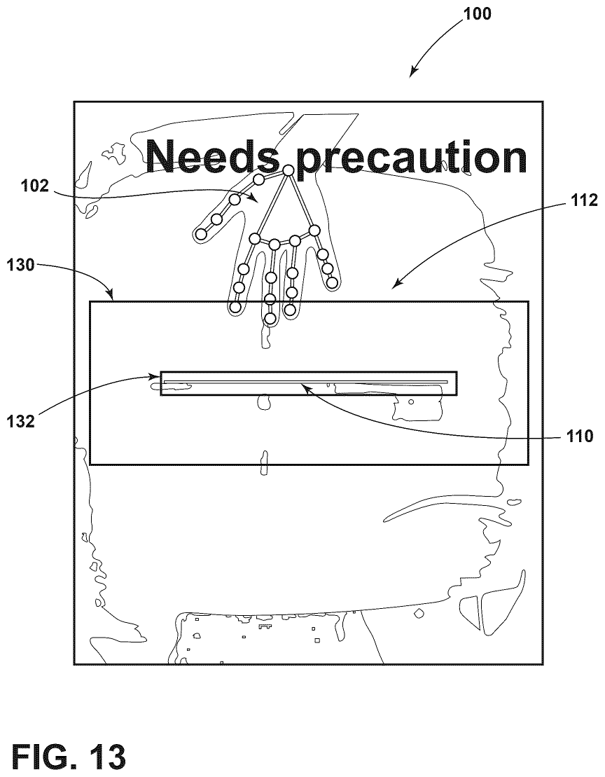

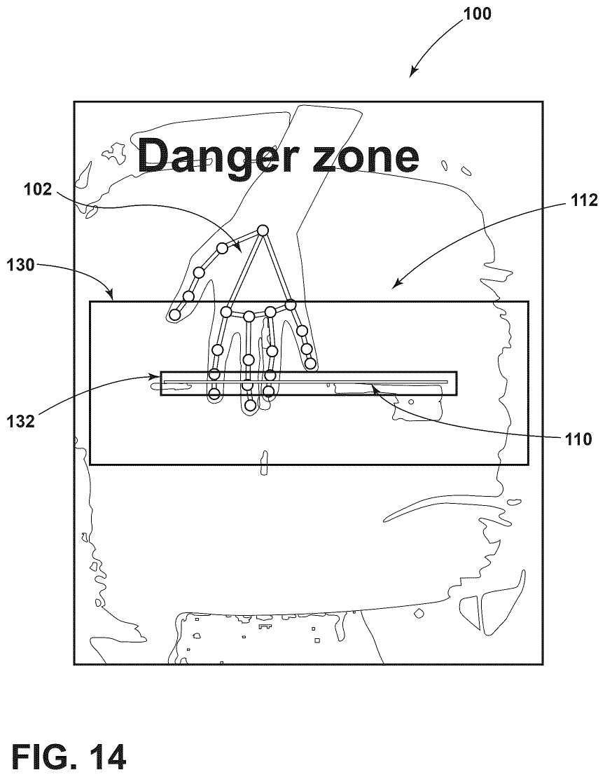

Referring to FIGS. 11-14, the human body part 102 is shown in various positions relative to the working element 110 and work surface 112. For example, FIG. 11 shows the human body part 102 outside of the warning zone 130 and the hazard zone 132. As illustrated in FIG. 12, the human body part 102 is within of the warning zone 130 and the hazard zone 132 in the at least one horizontal direction 142, however, it is outside of these zones in the vertical direction 144. As illustrated in FIG. 13 the human body part 102 is within of the warning zone 130 in both the at least one horizontal direction 142 and the vertical direction 144. As illustrated in FIG. 14 the human body part 102 is within of the hazard zone 132 in both the at least one horizontal direction 142 and the vertical direction 144.

In other embodiment of the machining system 100 of the present disclosure, the hazard detection system 140 can include at least one sensor configured to track a position of the at least one human body 102 part relative to the working element 110 in at least one first direction or plane parallel to the work surface 112 and at least one second direction or plane parallel to the working element 110, depending on the particular application. For instance, in table saws, the hazard detection system 140 can monitor a position of the human body part 102 in at least one first horizontal plane parallel with the horizontal work surface 112 and in a second direction parallel with the vertically oriented saw blade 110, or a side surface of the saw blade 110. In band saws however, a similar detection method could be used, or the hazard detection system 140 can monitor a position of the human body part 102 in at least one horizontal direction parallel with the work surface 112, and in at least one second plane parallel with the vertically moving saw blade 110. Therefore, two-dimensional motion can be detected in different embodiments either relative to the work surface 112 or relative to the working element 110 as appropriate. In certain optional embodiments, the sensors used for this two-plane tracking may include either a combined 3D sensor or a complementary pair of a 2D camera and a depth or range sensor, as discussed above. The controller 180 may fuse the signals from such sensors to provide accurate real-time tracking across both planes and analyze such data to identify hazardous situations occurring in either or both planes.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A machining system for wood or metal working, the machining system comprising:
a working element positioned adjacent to a work surface;
a hazard mitigation system operatively connected to the working element;
a hazard detection system positioned proximate to the working element, the hazard detection system including at least one sensor configured to track a position of at least one human body part relative to the working element in at least one horizontal direction and a vertical direction, the at least one horizontal direction parallel to the work surface and the vertical direction perpendicular to the work surface; and
a controller operatively connected to the hazard mitigation system and the hazard detection system, the controller configured to:
determine a position and/or movement of the at least one human body part relative to the working element based on outputs from the hazard detection system;
identify a hazardous situation based on the determined position and/or movement of the at least one human body part relative to the working element; and
activate the hazard mitigation system in response to the identified hazardous situation.

2. The machining system of claim 1, wherein the at least one sensor of the hazard detection system includes:
a two-dimensional camera configured to track the position of the at least one human body part relative to the working element in only the at least one horizontal direction; and
a depth sensor configured to track the position of the at least one human body part relative to the working element in the vertical direction.

3. The machining system of claim 1, wherein the at least one sensor of the hazard detection system includes:
a three-dimensional time of flight sensor configured to track the position of the at least one human body part relative to the working element in both the at least one horizontal direction and the vertical direction.

4. The machining system of claim 1, wherein:
the at least one sensor is positioned above the working element.

5. The machining system of claim 4, wherein:
the at least one sensor is positioned directly above the working element and coupled to a boom pole.

6. The machining system of claim 1, wherein:
the hazardous situation is based at least in part on the determined position of the at least one human body part being within a predetermined distance from the working element.

7. The machining system of claim 1, wherein:
the hazardous situation is based at least in part on the determined position of the at least one human body part being within a predefined hazard zone relative to the working element.

8. The machining system of claim 1, wherein:
the controller is further configured to identify a hazardous situation when a velocity of the human body part toward the working element exceeds a threshold.

9. The machining system of claim 1, wherein:
the hazard mitigation system is configured to retract the working element below the work surface in less than 50 milliseconds after identifying the hazardous situation.

10. The machining system of claim 1, wherein:
the hazard detection system includes a thermal imaging sensor configured to distinguish temperature differences between the human body part and a work piece.

11. The machining system of claim 1, wherein:
the controller is configured to employ a machine learning model trained to distinguish the human body part from a work piece.

12. The machining system of claim 1, wherein:
the hazard mitigation system is further configured to generate at least one of an auditory alarm and a visual alarm when the hazardous situation is detected.

13. A machining system for wood or metal working, the machining system comprising:
a working element positioned adjacent to a work surface;
a hazard mitigation system operatively connected to the working element;
a hazard detection system positioned proximate to the working element, the hazard detection system including at least one sensor configured to track a position of at least one human body part relative to the working element in at least one first direction or plane parallel to the work surface and at least one second direction or plane parallel to the working element; and
a controller operatively connected to the hazard mitigation system and the hazard detection system, the controller configured to:
determine a position and/or movement of the at least one human body part relative to the working element based on outputs from the hazard detection system;
identify a hazardous situation based on the determined position and/or movement of the at least one human body part relative to the working element; and
activate the hazard mitigation system in response to the identified hazardous situation.

14. The machining system of claim 13, wherein the at least one sensor of the hazard detection system includes:
a two-dimensional camera configured to track the position of the at least one human body part relative to the working element in only the first plane parallel to the work surface; and
a depth sensor configured to track the position of the at least one human body part relative to the working element in only the second plane parallel to the working element.

15. The machining system of claim 13, wherein the at least one sensor of the hazard detection system includes:
a three-dimensional time-of-flight sensor configured to track the position of the at least one human body part relative to the working element in both the first plane and the second plane.

16. The machining system of claim 13, wherein the at least one sensor is positioned above the working element.

17. The machining system of claim 13, wherein:
the hazardous situation is based at least in part on the determined position of the at least one human body part being within a predetermined distance from the working element in at least one of the first plane or the second plane.

18. The machining system of claim 13, wherein:
the hazardous situation is based at least in part on the determined position of the at least one human body part being within a predefined hazard zone relative to the working element in at least one of the first plane or the second plane.

19. The machining system of claim 13, wherein:
the controller is further configured to identify a hazardous situation when a velocity of the human body part toward the working element within the first plane or the second plane exceeds a threshold.

20. The machining system of claim 13, wherein:
the hazard detection system includes a thermal imaging sensor configured to distinguish temperature differences between the human body part and a work piece.
